(19) United States
(12) Patent Application Publication
(10) Pub. No.: US 2022/0235246 A1
(43) Pub. Date: Jul. 28, 2022

(54) HYDROPHOBIC SURFACE COATING FOR VIRUS INACTIVATION AND METHODS THEREFOR

(71) Applicant: Purdue Research Foundation, West Lafayette, IN (US)

(72) Inventors: Tanya Purwar, Lafayette, IN (US); Victor-Manuel Castano-Meneses, Queretaro (MX); Xing Li, West Lafayette, IN (US); Ernest R. Blatchley, III, Lafayette, IN (US); Luciano Castillo, Carmel, IN (US); Ali Doottalab, Lubbock, TX (US)

(21) Appl. No.: 17/586,319

(22) Filed: Jan. 27, 2022

Related U.S. Application Data
(60) Provisional application No. 63/142,780, filed on Jan. 28, 2021.

(51) Int. Cl. C09D 183/04; B05D 5/08; C09D 127/12; B05D 1/04; C09D 5/00

(52) U.S. Cl. CPC C09D 183/04; B05D 5/08; C09D 5/00; B05D 1/04; C09D 127/12

(57) ABSTRACT

Methods of enhancing the anti-virus capabilities of surfaces directly contacted by humans. The methods include applying a hydrophobic coating material to a surface of an article to form a hydrophobic surface coating overlying the surface such that the hydrophobic surface coating defines a hydrophobic outer surface of the article. The hydrophobic outer surface is more hydrophobic than the surface of the article, and a liquid that contains suspended viruses and is deposited on the hydrophobic outer surface exhibits a contact angle relative to the hydrophobic outer surface that is greater than a contact angle of the liquid if directly deposited on the surface of the article, and the hydrophobic outer surface thereby increases inactivation of the viruses suspended in the liquid as compared to the surface of the article to which the hydrophobic coating material was applied.

### CROSS-REFERENCE TO RELATED APPLICATIONS

This application claims the benefit of U.S. Provisional Application No. 63/142,780, filed Jan. 28, 2021, the contents of which are incorporated herein by reference.

### BACKGROUND OF THE INVENTION

The present invention generally relates to methods and materials for reducing the ability of a surface to carry and transmit viruses and pathogens and/or to reduce the need to frequently disinfect a surface. The present invention more particularly relates to the use of hydrophobic surface coatings to enhance the anti-virus capabilities of surfaces.

In December 2019, patients with viral pneumonia of unknown cause were reported in Wuhan, China. Referred to as Coronavirus disease 2019 (COVID-19), a novel coronavirus was subsequently identified as the causative pathogen, provisionally named 2019 novel coronavirus (2019-nCoV), now known as severe acute respiratory syndrome coronavirus 2 (SARS-CoV-2). Like all coronaviruses, SARS-CoV-2 has a minimum of three viral proteins, namely, a glycoprotein spike protein (S), a membrane protein (M) that spans the membrane of the coronavirus, and an envelope protein (E), which is a highly hydrophobic protein that covers the entire structure of the coronavirus (FIG. 1). The spike (S) glycoprotein in the coronavirus recognizes the host cell receptors and causes an important role in viral infection.

The National Institutes of Health (NIH) has studied viruses deposited from an infected person onto everyday surfaces in household and hospital settings, such as through coughing or touching objects. NIH scientists found that SARS-CoV-2 was detectable in aerosols for up to three hours, on copper for up to four hours, on cardboard for up to twenty-four hours, and on plastic and stainless steel for up to two to three days. The results provided key information about the stability of SARS-CoV-2, and suggested that people may acquire the virus through the air and after touching contaminated objects. Of particular concern are surfaces that may be referred to as “high-touch” surfaces. FIG. 2 is a figure reproduced from Huslage et al., “A Quantitative Approach to Defining ‘High-Touch’ Surfaces in Hospitals,” Infection Control and Hospital Epidemiology, Vol. 31, No. 8 (August 2010), pp. 850-853, and contains a useful indication of what might be deemed “high-touch” surfaces in a hospital setting, for example, at least one contact with a surface per each interaction within a given location, in other words, at least one contact with a surface each time an individual enters the environment in which the article is located.

The physical characteristics of viruses need to be understood in order to manipulate the interaction of viruses with host cells, as well as to create specific molecular recognition techniques to detect, purify, and remove viruses. The hydrophobicity of a protein or a virus is difficult to quantify. The hydrophobic strength of the core of a protein is believed to give the protein structural stability.

The hydrophobicity of surfaces can be determined by the oscillation of water molecules in molecular dynamic simulations. To have a more quantitative measure of a hydrophobic surface, the cavity formation of the water structure is needed. Such a study is vital to understanding the nature of the spread of a virus apart from direct human (species) interaction and can help determine methods and materials that can lead to safety upgrades in infection-prone scenarios. The extent to which viral pathogens of humans and animals persist in the environment to reach other hosts is of considerable public health interest and concern.

Studies have shown that phenomena influencing virus interactions with and survival on surfaces include virus type, virus physical state (dispersed, aggregated, or solids-associated; the extent and state of virus adsorption), temperature, particles and suspended matter, organic matter, salts, pH, specific antiviral chemicals, UV radiation in sunlight, relative humidity, moisture content and water activity. The extent and state of virus adsorption have an important influence on virus survival on surfaces and in soils. Studies have shown that viruses become inactivated and proteins lose activity upon exposure to air-water interfaces (AWI). However, when the viruses are in a three-part system consisting of an aqueous medium, a surface, and air, referred to as a triple-phase-boundary (TPB) system, stronger inactivation is expected. A TPB system is schematically represented in FIG. 3, which is a figure reproduced from Thompson et al., “Role of the Air-Water-Solid Interface in Bacteriophage Sorption Experiments,” Applied and Environmental Microbiology, Vol. 64, No. 1, p.304-309 (1998). Thompson et al. hypothesized that viruses in solution reach the AWI, where they adsorb, via convection and diffusion. This adsorption is dominated by electrostatic, hydrophobic, hydration, and capillary forces, solution ionic strength, pH, and various other factors. As a virus adsorbs to the AWI, hydrophobic domains on the protein surface (e.g., the capsid of a nonenveloped virus) partition out of the solution and into the more nonpolar gas phase. Thompson et al. suggested that such exposed domains on the virus capsid are susceptible to forces at the TPB that are not present at the AWI itself.

Unlike the AWI, the balance of forces at the TPB will be influenced by the surface characteristics of the solid. The forces acting on the aqueous droplet, namely, the solid-air, solid-water, and air-water surface tensions, will balance at equilibrium and can be described by a contact angle, which is the cosine of the angle of contact between a liquid and a solid. See FIGS. 4 and 5, which are also figures from Thompson et al. Therefore, it is proposed that virus particles partitioned at the TPB experience destructive forces as a result of the reconfiguration of water molecules near the surface. These TPB effects are more likely to occur when the surface is hydrophobic, as was demonstrated in the study by Thompson et al.

### BRIEF SUMMARY OF THE INVENTION

The present invention provides methods of enhancing the anti-virus capabilities of surfaces.

According to one aspect of the invention, a method is provided for increasing inactivation of viruses that come into contact with an article that is directly contacted by humans when the article is handled by humans. The method includes applying a hydrophobic coating material to a surface of the article to form a hydrophobic surface coating overlying the surface. The hydrophobic surface coating defines a hydrophobic outer surface of the article that is directly contacted by humans when the article is handled by humans, and the hydrophobic outer surface is more hydrophobic than the surface of the article to which the hydrophobic coating material was applied. By depositing on the hydrophobic outer surface a liquid in which viruses are suspended, the liquid exhibits a contact angle relative to the hydrophobic outer surface that is greater than a contact angle of the liquid relative to the surface of the article to which the hydrophobic coating material was applied if the liquid were directly deposited on the surface of the article without the hydrophobic surface coating, and the hydrophobic outer surface thereby increases inactivation of the viruses suspended in the liquid as compared to the surface of the article to which the hydrophobic coating material was applied.

Other aspects and advantages of this invention will be appreciated from the following detailed description.

### BRIEF DESCRIPTION OF THE SEVERAL VIEWS OF THE DRAWING

FIG. 1 schematically represents the structure of a coronavirus.

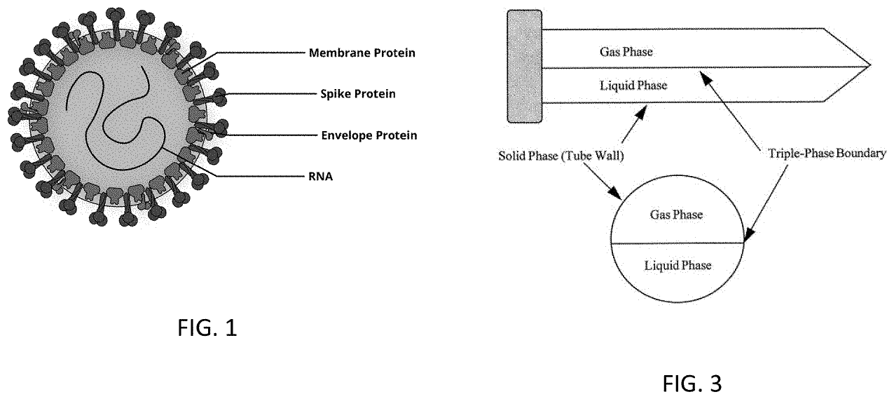

FIG. 2 is a chart containing an indication of what is referred to herein as “high-touch” surfaces in a hospital setting.

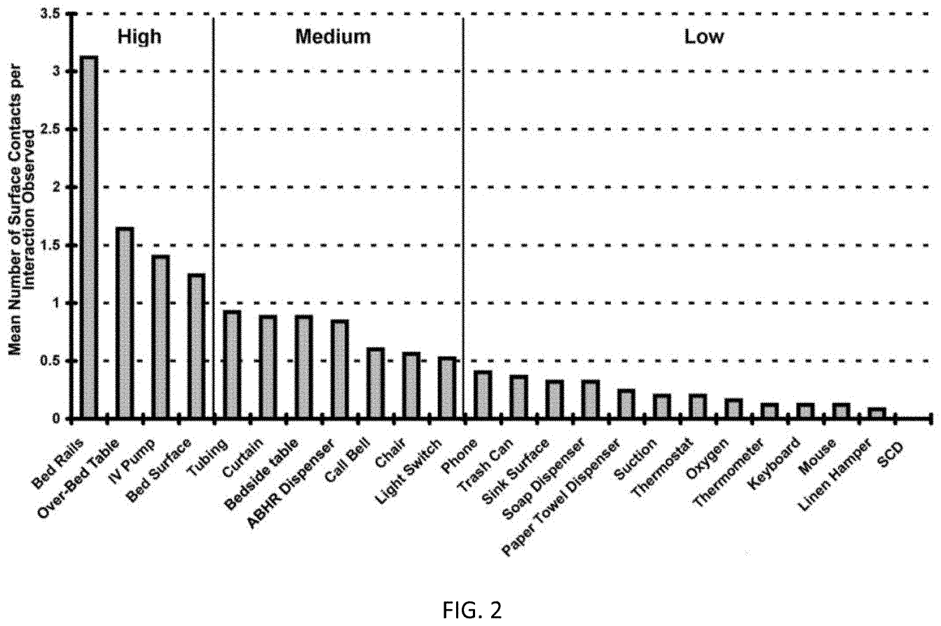

FIG. 3 schematically represents a polypropylene tube partially filled with a phage suspension, and identifies the air, water, and solid phases of the system as well as a triple-phase-boundary (TPB).

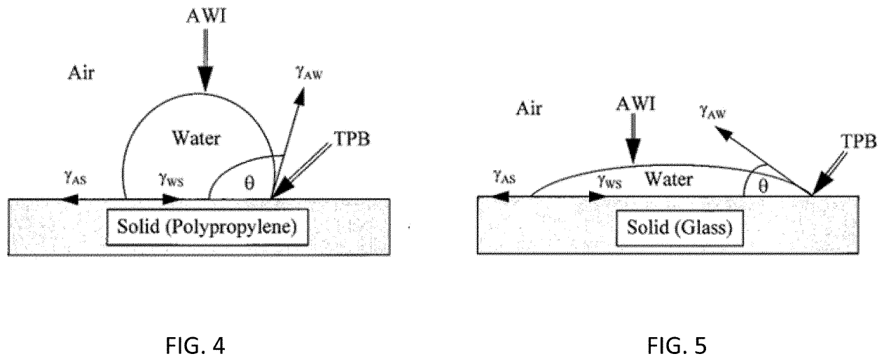

FIGS. 4 and 5 schematically represent water droplets resting on, respectively, a relatively hydrophobic polypropylene (PP) surface and a glass surface, and identifies the equilibrium forces as (γ_{AW}, γ_{WS}, and γ_{AS}), the air-water interface (AWI), and the triple phase boundary (TPB).

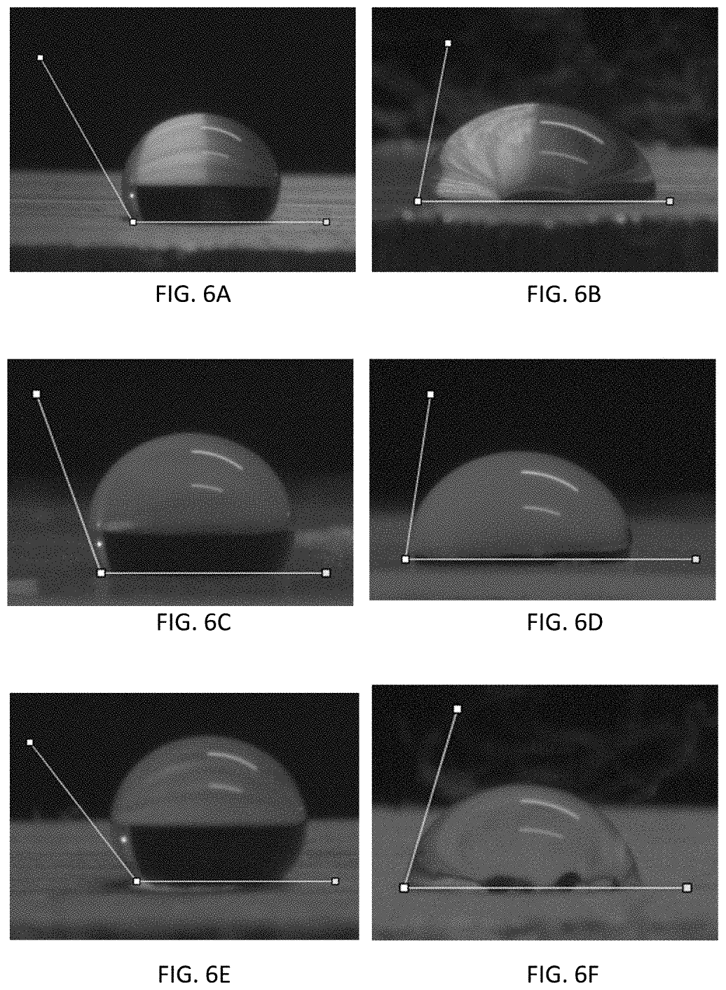

FIGS. 6A, 6C, and 6E are images depicting water droplets on aluminum, rubber, and wood substrates with a hydrophobic surface coating on the surface of each substrate contacted by the droplets, and FIGS. 6B, 6D, and 6F are images depicting water droplets on aluminum, rubber, and wood substrates without a hydrophobic surface coating on the surface of each substrate contacted by the droplets.

FIG. 7 contains a bar graph evidencing contact angles formed by water droplets on a variety of substrates with and without a hydrophobic surface coating.

FIGS. 8A and 8B contain bar graphs evidencing increased viral log reduction observed for polypropylene and aluminum substrates having a hydrophobic surface coating compared to polypropylene and aluminum substrates without a hydrophobic surface coating.

FIGS. 9A and 9B schematically represent liquid droplets resting, respectively, on a surface of an article that is not coated with a hydrophobic surface coating and on a surface of a hydrophobic surface coating on the article, and represents the thermodynamic equilibrium between three phases, liquid (L), solid (S), and gas (G), with the equilibrium force between the liquid and gas phases identified as γ_{LG}, the equilibrium force between the solid and liquid phases identified as γ_{SL}, and the contact angle therebetween as θ_{C}.

### DETAILED DESCRIPTION OF THE INVENTION

The intended purpose of the following detailed description of the invention and the phraseology and terminology employed therein is to describe what is shown in the drawings, which relate to one or more nonlimiting embodiments of the invention, and to describe certain but not all aspects of what is depicted in the drawings, including the embodiment(s) to which the drawings relate. The following detailed description also describes certain investigations relating to the embodiment(s), and identifies certain but not all alternatives of the embodiment(s). Therefore, the appended claims, and not the detailed description, are intended to particularly point out subject matter regarded as the invention, including certain but not necessarily all of the aspects and alternatives described in the detailed description.

On the basis that viruses become inactivated and proteins lose activity upon exposure to air-water interfaces (AWI) and stronger inactivation is expected at the triple-phase-boundary (TPB) of a three-part system comprising an aqueous medium, a solid surface, and air, the following disclosure utilizes these properties to increase virus inactivation with the use of coatings that are strongly hydrophobic.

Experiments were conducted with surfaces having different wettabilities for the purpose of determining the effect on virus inactivation due to interfacial forces in a static triple-phase-boundary system. For the experiments, low wettability surfaces were formed with Rust-Oleum® 278146 Never-Wet Outdoor Fabric Spray, a silicone-based hydrophobic and lipophobic coating material having an ultra-low volatile organic compound (VOC) content and able to be applied by electrostatic spraying methods. This hydrophobic coating material was selected in part on the basis of being reported as superhydrophobic.

Specimen substrate materials used in the experiments included wood, polymer, and metals, in particular, wood, polytetrafluoroethylene (PTFE), polypropylene (PP), polyvinyl chloride (PVC), polyethylene (PE), natural rubber (mainly polyisoprene), copper, aluminum, stainless steel, and cast iron.

Viruses used in the experiments were Escherichia virus MS2 (MS2) and Pseudomonas virus phi6 (phi6) bacteriophages. MS2 is a nonenveloped, single stranded RNA, and Phi6 is an enveloped, double stranded RNA.

The experiments employed saliva as the liquid from which wettabilities of different surfaces were determined, though it should be understood that viruses can be and often are transferred or dispersed while suspended in other liquids. A notable but nonlimiting example is nasal fluid, which deposits on articles and is dispersed in the air as a result of sneezing.

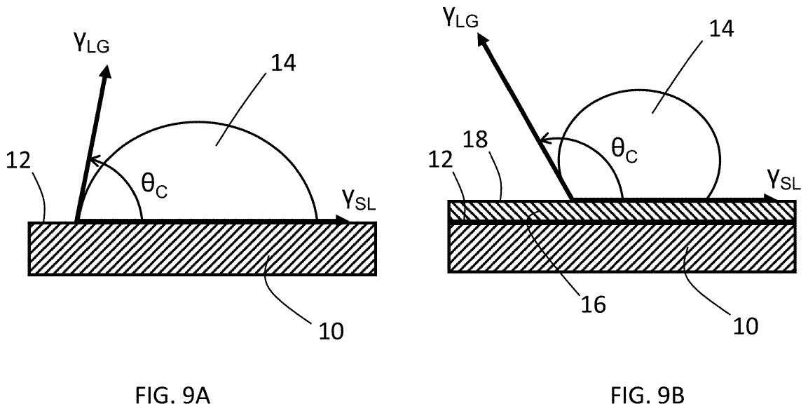

The following test techniques were performed. Specimen substrates of the different specimen substrate materials were obtained. Surfaces of some of the specimen substrates were coated with the hydrophobic coating material, while the remaining specimen substrates remained uncoated. Using pipettes, a liquid (saliva) droplet was suspended on each coated and uncoated specimen substrate, and contact angles of the droplets were measured using a sessile drop test. As used herein, the term “contact angle(s)” refers to the contact angle of a liquid droplet relative to a surface of a solid on which the droplet is supported. As schematically represented in FIGS. 9A and 9B, the contact angle (θ_{C}) refers to the angle between the equilibrium force between the liquid and gas phases identified as γ_{LG}, and the equilibrium force between the solid and liquid phases identified as γ_{SL}. Droplets of the following combinations were used: MS2+saliva, phi6+saliva, and MS2/phi6+saliva. The MS2+saliva and phi6+saliva droplets were suspended on both a coated and an uncoated specimen of each substrate material, whereas the MS2/phi6+saliva droplet was suspended on only a coated specimen of each substrate material. The MS2/phi6+saliva droplet on there coated specimen substrates were immediately transferred to a centrifuge tube, whereas the remaining droplets rested for sixty minutes before being transferred to a centrifuge tube.

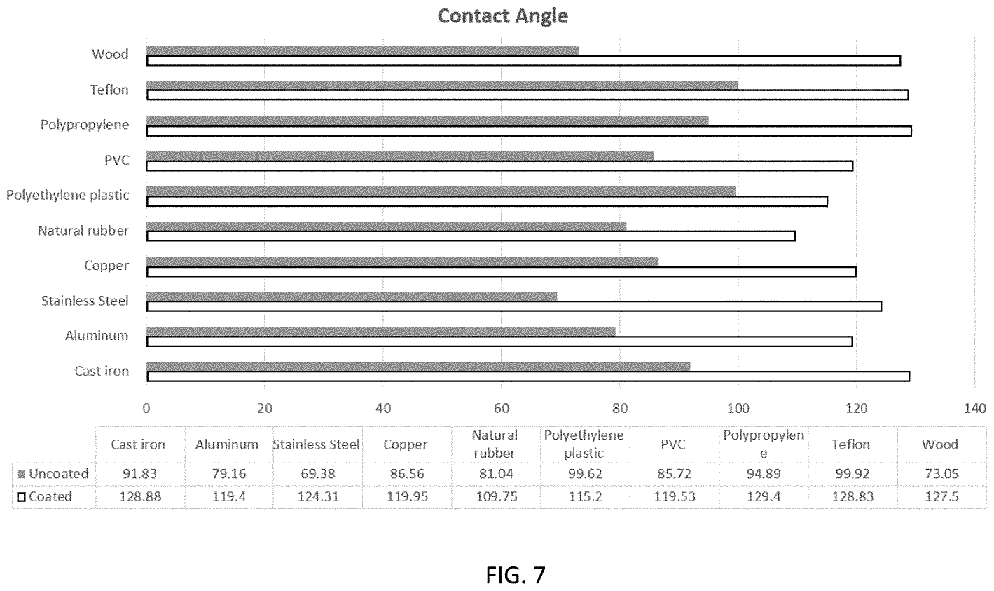

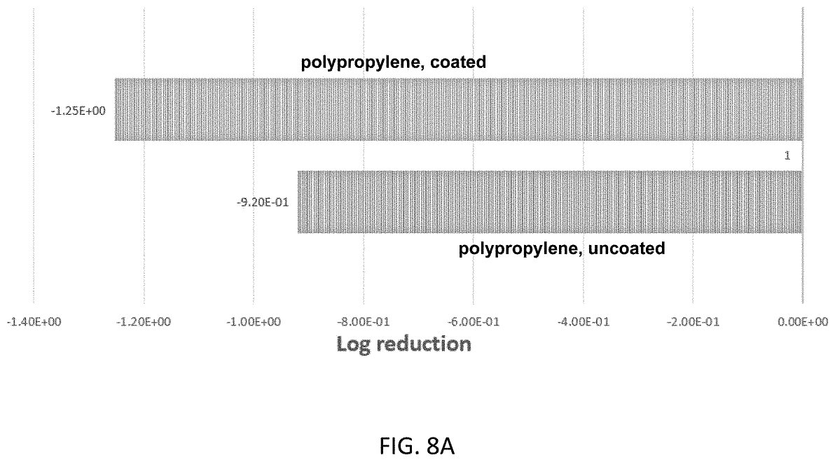

FIGS. 6A through 6F are images of water droplets on coated and uncoated aluminum specimens (FIGS. 6A and 6B), coated and uncoated natural rubber specimens (FIGS. 6C and 6D), and coated and uncoated wood specimens (FIGS. 6E and 6F). The images are annotated with lines identifying the coated and uncoated surfaces and the contact angles of the water droplets on the surfaces. FIG. 7 contains a bar graph and table of the measured contact angles of the water droplets for all tested coated and uncoated specimen substrates. These results evidenced a marked reduction in the contact angle resulting from the hydrophobic coating material of the coated specimen substrates. As evident from comparing the images of FIGS. 6A through 6F and 7, the hydrophobic surface coatings consistently exhibited contact angles of greater than 90 degrees, for example, greater than 100 degrees to about 130 degrees, whereas the surfaces of the same substrates without the hydrophobic surface coatings consistently exhibited contact angles of less than 100 degrees, more typically less than 90 degrees.

Virus inactivation of phi6 bacteriophages was investigated with aluminum and polypropylene as specimen substrate materials. One of each specimen substrate material was coated with the hydrophobic coating material, and one of each specimen substrate material remained uncoated. Four drops of a 7-microliter phi6 stock were applied with a pipette to each coated and uncoated specimen substrate. The droplets were allowed to rest on their surfaces for thirty minutes, after which a 10 mL broth was used to extract bacteriophages from each surface.

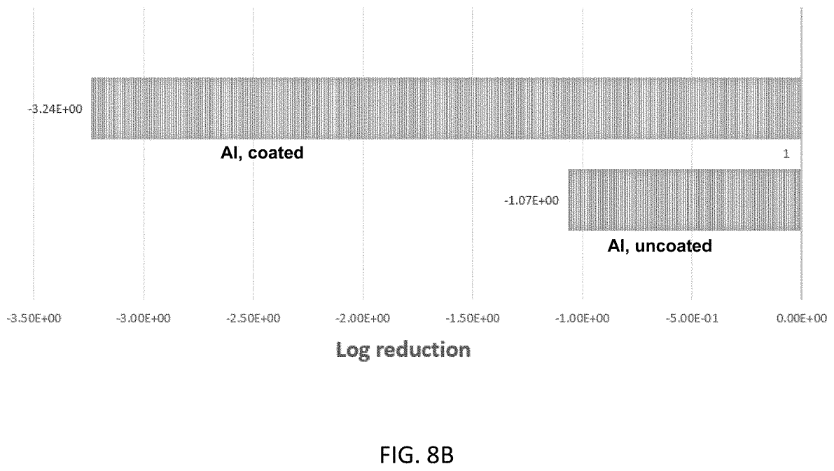

Phi6 inactivation was determined using a plaque assay test, which is a widely used approach for determining the quantity of infectious viruses in a sample. Only viruses that cause visible damage to cells can be assayed in this way. The number of plaques that develop and the appropriate dilution factors can be used to calculate the number of bacteriophages, i.e., plaque-forming units (PFU) in a sample. FIGS. 8A and 8B are graphs that plot the results of the experiment, and evidence a marked increase in phi6 inactivation resulting from the hydrophobic coating material. The coated polypropylene specimen substrate exhibited a 1.25 log reduction (>90% reduction) compared to the uncoated polypropylene specimen substrate, and the coated aluminum specimen substrate exhibited a 3.24 log reduction (>99.9% reduction) compared to the uncoated aluminum specimen substrate. Referring back to the results of the sessile drop test, it should be noted that the hydrophobic coating material increased the contact angle of a polypropylene surface by about 36%, and the hydrophobic coating material increased the contact angle of an aluminum surface by about 50%. Consequently, it appears that there may be a correlation between the reduction of virus activity (increase in virus inactivation) and the extent to which the contact angle is increased as a resulting of applying a hydrophobic coating material to a substrate surface.

Illustrative of the results discussed in reference to FIGS. 6A through 8B, FIGS. 9A and 9B schematically represent liquid droplets 14 resting, respectively, on a surface 12 of an article 10 that is not coated with a hydrophobic surface coating and on a surface 18 of a hydrophobic surface coating 16 formed with a hydrophobic coating material on the surface 12 of the article 10. FIGS. 9A and 9B also represent the thermodynamic equilibrium between three phases, liquid (L), solid (S), and gas (G), with the equilibrium force between the liquid and gas phases identified as γ_{LG}, the equilibrium force between the solid and liquid phases identified as γ_{SL}, and the contact angle therebetween as θ_{C}. From FIG. 9B, it can be appreciated that the surface 18 of the hydrophobic surface coating 16 is a hydrophobic outer surface 18 of the article 10 and would be directly contacted by humans when the article 10 is handled by humans. Furthermore, by comparing FIGS. 9A and 9B it can be appreciated that the hydrophobic outer surface 18 of FIG. 9B is more hydrophobic than the surface 12 of the article 10 to which the hydrophobic coating material was applied. In particular, the liquid droplet 14 exhibits a contact angle (θ_{C}) relative to the hydrophobic outer surface 18 that is greater than the contact angle (θ_{C}) of the liquid droplet 14 relative to the surface 12 of the article 10. According to the investigations reported herein, the hydrophobic outer surface 18 increases inactivation of viruses suspended in the droplet 14 of FIG. 9B as compared to viruses suspended in the droplet 14 on the surface 12 of the article 10 of FIG. 9A.

The investigations discussed above evidenced that hydrophobicity (resulting in low wettability) of a surface contacted by a liquid containing suspended viruses was a crucial parameter in the cause of virus inactivation on surfaces. Consequently, it was concluded that a hydrophobic surface coating that is continuous and uninterrupted over a surface of a substrate will create a hydrophobic surface coating that increases virus inactivation as compared to the original surface of the substrate. In regard to articles handled by humans, surfaces of such articles that are frequently handled by humans are believed to particularly benefit as a result of increased inactivation of viruses that are deposited on the surfaces.

While the invention has been described in terms of particular investigations, it should be apparent that alternatives could be adopted by one skilled in the art. For example, other hydrophobic coating materials and substrate materials could be substituted for those used in the investigations. Notable examples of other hydrophobic coating materials include super hydrophobic and super lipophobic coating compositions that comprise polydimethylsiloxane and optionally may contain functionalized carbonaceous nanoparticles, and fluoropolymer coatings that optionally may contain functional groups. Accordingly, it should be understood that the invention is not necessarily limited to any particular embodiment or investigation described herein or illustrated in the drawings. It should also be understood that the purpose of the above detailed description and the phraseology and terminology employed therein is to describe the investigations, and not necessarily to serve as limitations to the scope of the invention. Therefore, the scope of the invention is to be limited only by the following claims.

1. A method of increasing inactivation of viruses that come into contact with an article that is directly contacted by humans when the article is handled by humans, the method comprising:
applying a hydrophobic coating material to a surface of the article to form a hydrophobic surface coating overlying the surface, the hydrophobic surface coating defining a hydrophobic outer surface of the article that is directly contacted by humans when the article is handled by humans, the hydrophobic outer surface being more hydrophobic than the surface of the article to which the hydrophobic coating material was applied; and
depositing on the hydrophobic outer surface a liquid in which viruses are suspended, the liquid exhibiting a contact angle relative to the hydrophobic outer surface that is greater than a contact angle of the liquid relative to the surface of the article to which the hydrophobic coating material was applied if the liquid were directly deposited on the surface of the article without the hydrophobic surface coating and the hydrophobic outer surface thereby increasing inactivation of the viruses suspended in the liquid as compared to the surface of the article to which the hydrophobic coating material was applied.

2. The method according to claim 1, wherein the hydrophobic surface coating is continuous and uninterrupted.

3. The method according to claim 1, wherein the liquid is saliva or nasal fluid.

4. The method according to claim 1, wherein the liquid is deposited on the hydrophobic outer surface as one or more droplets.

5. The method according to claim 1, wherein the contact angle of the liquid relative to the surface of the article is less than 90 degrees and the contact angle of the liquid relative to the hydrophobic outer surface is greater than 90 degrees.

6. The method according to claim 1, wherein the contact angle of the liquid relative to the surface of the article is less than 100 degrees and the contact angle of the liquid relative to the hydrophobic outer surface is greater than 100 degrees to about 130 degrees.

7. The method according to claim 1, wherein the contact angle of the liquid relative to the hydrophobic outer surface is at least 36% greater than the contact angle of the liquid relative to the surface of the article.

8. The method according to claim 1, wherein the contact angle of the liquid relative to the hydrophobic outer surface is at least 50% greater than the contact angle of the liquid relative to the surface of the article.

9. The method according to claim 1, wherein the hydrophobic coating material is a silicone-based material, polydimethylsiloxane, or a fluoropolymer.

10. The method according to claim 1, wherein the hydrophobic coating material is lipophobic.

11. The method according to claim 1, wherein the hydrophobic coating material is applied by electrostatic spraying.

12. The method according to claim 1, wherein the article is a high-touch object in a medical facility.

13. The method according to claim 1, wherein the surface of the article is formed by a material chosen from the group consisting of wood, polymers, and metals.

14. The method according to claim 1, wherein the surface of the article is formed by a material chosen from the group consisting of wood, polytetrafluoroethylene, polypropylene, polyvinyl chloride, polyethylene, natural rubber, copper, aluminum, stainless steel, and cast iron.
